(19) United States
(12) Patent Application Publication
(10) Pub. No.: US 2026/0018789 A1
(43) Pub. Date: Jan. 15, 2026

(54) DRIVING METHOD FOR INTELLIGENCE REFLECTING SURFACE

(71) Applicant: Japan Display Inc., Tokyo (JP)

(72) Inventors: Mitsutaka OKITA, Tokyo (JP); Daijiro TAKANO, Tokyo (JP); Masayuki IKARI, Tokyo (JP)

(73) Assignee: Japan Display Inc., Tokyo (JP)

(21) Appl. No.: 19/330,875

(22) Filed: Sep. 17, 2025

Related U.S. Application Data
(63) Continuation of application No. PCT/JP2024/002215, filed on Jan. 25, 2024.

(30) Foreign Application Priority Data
Mar. 27, 2023 (JP) 2023-049893

(51) Int. Cl. H01Q 3/46; H01Q 15/14; H01Q 19/10

(52) U.S. Cl. CPC H01Q 3/46; H01Q 15/148; H01Q 19/104

(57) ABSTRACT

A driving method for an intelligent reflecting surface, the intelligent reflecting surface includes an output signal line and a reflector unit cell electrically connected to the output signal line and having a first electrode, a second electrode, and a liquid crystal layer provided between the first electrode and the second electrode. The driving method includes transmitting a common voltage to the second electrode in a plurality of consecutive subframe periods and transmitting an output signal to the reflector unit cell through a the output signal line. The output signal includes a voltage corresponding to a phase for reflecting an incident radio wave in a predetermined direction in each adjacent subframe period among the plurality of subframe periods. Each of the reflector unit cells receives the voltage in each adjacent subframe period among the plurality of subframe periods and generates one voltage using the plurality of voltages.

### CROSS-REFERENCE TO RELATED APPLICATIONS

This application is a Continuation of International Patent Application No. PCT/JP2024/002215, filed on Jan. 25, 2024, which claims the benefit of priority to Japanese Patent Application No. 2023-049893, filed on Mar. 27, 2023, the entire contents of each are incorporated herein by reference.

### FIELD

An embodiment of the present invention relates to a driving method for an intelligent reflecting surface (a radio wave reflecting device) that can control a traveling direction of reflected radio waves.

The introduction of the fifth-generation communication standard called 5G is advancing in the communication field. Frequencies in the millimeter-wave band (26 GHz or higher, e.g., 26 GHz to 29 GHZ) are employed in this communication standard. Communication according to the 5G standard can achieve very high-throughput by adopting a millimeter-wave band frequency, and can be transmitted over a wide bandwidth.

For example, to change a transmission direction of a radio wave and to widen the communication area while avoiding obstacles, an attempt is made to use a meta surface in communication according to the 5G standard. The meta surface includes a plurality of antenna elements arranged in a plane. A signal including a voltage corresponding to a predetermined phase is transmitted to each of the plurality of antenna elements. As a result, the meta surface can control the directivity of the antenna in a state where each of the plurality of antenna elements is fixed. For example, a meta surface is known that adjusts an amplitude and a phase of a high-frequency signal transmitted to each of the plurality of antenna elements and utilizes a change in a dielectric constant due to an alignment state of a liquid crystal.

### SUMMARY

A driving method for an intelligent reflecting surface includes a first output signal line to an mth (m is an integer of 2 or more) output signal line; and a plurality of reflector unit cells each electrically connected to a corresponding one of the first output signal line to the mth output signal line, each having a first electrode, a second electrode, and a liquid crystal layer provided between the first electrode and the second electrode. The driving method includes transmitting a common voltage to the second electrode in a plurality of consecutive subframe periods included in a frame period, and transmitting an output signal to the plurality of reflector unit cells through the first output signal line to the mth output signal line in each period of the plurality of subframe periods. The output signal includes a voltage corresponding to a phase for reflecting an incident radio wave in a predetermined direction during each adjacent subframe period among the plurality of subframe periods. Each of the plurality of reflector unit cells receives a voltage corresponding to the phase during each of the adjacent subframe periods among the plurality of subframe periods, and generates one voltage using the voltages corresponding to the plurality of phases.

### BRIEF DESCRIPTION OF DRAWINGS

FIG. 1 is a plan view showing a configuration of a radio wave reflecting device according to a first embodiment of the present invention.

FIG. 2 is a plan view showing a configuration of a radio wave reflecting device according to a first embodiment of the present invention.

FIG. 3 is a plan view showing a configuration of a reflector unit cell shown in FIG. 2.

FIG. 4 is a cross-sectional view showing a cut surface taken along a line B1-B2 shown in FIG. 3.

FIG. 5 is a cross-sectional view showing a cut surface taken along a line A1-A2 shown in FIG. 1, and is a diagram schematically showing that a traveling direction of a reflected wave is changed by a radio wave reflecting device according to the first embodiment of the present invention.

FIG. 6A is a diagram showing a state in which a voltage is not applied between a bias electrode and a common electrode in a reflector unit cell used in a radio reflecting device according to the first embodiment of the present invention.

FIG. 6B is a diagram showing a state in which a voltage is applied between a bias electrode and a common electrode in a reflector unit cell used in a radio reflecting device according to the first embodiment of the present invention.

FIG. 7 is a diagram showing a state in which a voltage is applied between a bias electrode and a common electrode in a reflector unit cell used in a radio reflecting device according to the first embodiment of the present invention.

FIG. 8 is a timing chart showing a driving method for a radio wave reflecting device according to the first embodiment of the present invention.

FIG. 9 is a diagram showing voltages (gradation setting voltages) that can be generated (set) by a reflector unit cell according to the first embodiment of the present invention.

FIG. 10 is a graph showing a relationship between voltages (gradation setting voltages) that can be generated (set) by a reflector unit cell and phases according to the first embodiment of the present invention.

FIG. 11 is a timing chart showing a driving method for a radio wave reflecting device according to a second embodiment of the present invention.

FIG. 12 is a timing chart showing a driving method for a radio wave reflecting device according to a third embodiment of the present invention.

FIG. 13 is a timing chart showing a driving method for a radio wave reflecting device according to a fourth embodiment of the present invention.

FIG. 14 is a timing chart showing a driving method for a radio wave reflecting device according to a fifth embodiment of the present invention.

### DESCRIPTION OF EMBODIMENTS

A radio wave reflecting device represented by a meta surface can apply a voltage corresponding to a predetermined phase to each of a plurality of antenna elements by using a driving circuit included in the radio wave reflecting device. For example, the smaller the number of voltages (e.g., output gradation voltages) corresponding to a predetermined phase, the simpler the configuration of the driving circuit, so that the size and manufacturing cost of the driving circuit can be suppressed. On the other hand, in the case where the number of output grayscale voltages is small, a predetermined phase that the radio wave reflecting device can accommodate is small, and the reflection characteristics of the radio wave reflecting device may be deteriorated.

In view of such background, an embodiment of the present invention relates to a driving method for the radio wave reflection device capable of suppressing deterioration of the reflection characteristics.

Hereinafter, embodiments of the present invention will be described with reference to the drawings and the like. However, the present invention can be implemented in many different aspects, and should not be construed as being limited to the description of the embodiments exemplified below. In order to make the description clearer, the drawings may be schematically represented with respect to the width, thickness, shape, and the like of each part as compared with the actual embodiment, but the drawings are merely examples, and do not limit the interpretation of the present invention. Further, in the present specification and the drawings, elements similar to those described above with respect to the above-described figures are denoted by the same reference signs (or reference signs denoted by a, b, and the like) and detailed description thereof may be omitted as appropriate. Furthermore, the terms “first” and “second” with respect to the respective elements are convenient signs used to distinguish the respective elements, and do not have any further meaning unless otherwise specified.

In the present specification, when a member or region is “above (or below)” another member or region, without limitation, it includes the case where it is directly above (or below) the other member or region, but also the case where it is above (or below) the other member or region, i.e., the case where another component is included between above (or below) the other member or region.

In the present specification, a direction D1 intersects a direction D2, and a direction D3 intersects the direction D1 and the direction D2 (D1D2 plane). The direction D1 is referred to as a first direction, the direction D2 is referred to as a second direction, and the direction D3 is referred to as a third direction. For example, the direction D1, the direction D2, and the direction D3 correspond to a direction X (direction x), a direction Y (direction y), and a direction Z (direction z).

In the present specification, in the case where the terms “same” and “match” are used, the “same” and “match” may include errors within the scope of the design.

### First Embodiment

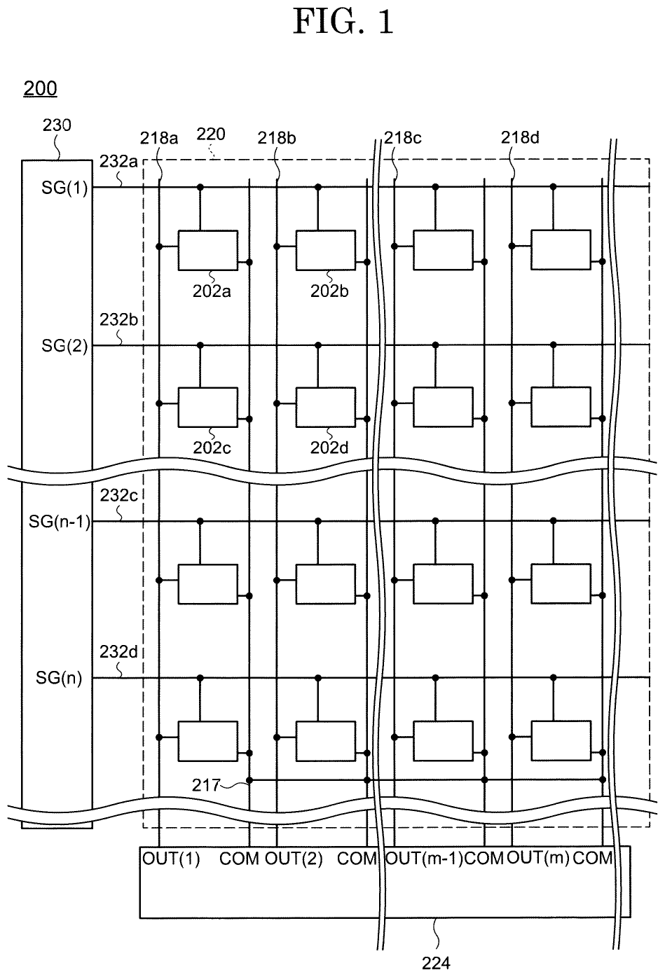

A radio wave reflecting device 200 according to the first embodiment will be described with reference to FIG. 1 to FIG. 10. The radio wave reflecting device 200 is a device having a function of reflecting a radio wave using a meta surface (a reflector 220) utilizing a change in a dielectric constant due to an alignment state of a liquid crystal. The radio wave reflection device 200 has a configuration that allows biaxial reflection control.

### 1. Overview of Radio Wave Reflecting Device 200

An outline of the radio wave reflection device 200 will be described with reference to FIG. 1. FIG. 1 is a plan view showing a configuration of the radio wave reflecting device 200.

As shown in FIG. 1, the radio wave reflecting device 200 includes a first driving circuit 224, a second driving circuit 230, a first scanning line 232a to n-th (n is an integer of 2 or more) scanning line 232d, a first output signal line 218a to m-th (m is an integer of 2 or more) output signal line 218d, and the reflector 220 including a plurality of reflector unit cells 202. For example, each of the plurality of reflector unit cells 202 is a plurality of reflector unit cells 202a to 202d. The reflector 220 may be referred to as a radio wave reflecting device (intelligent reflecting surface).

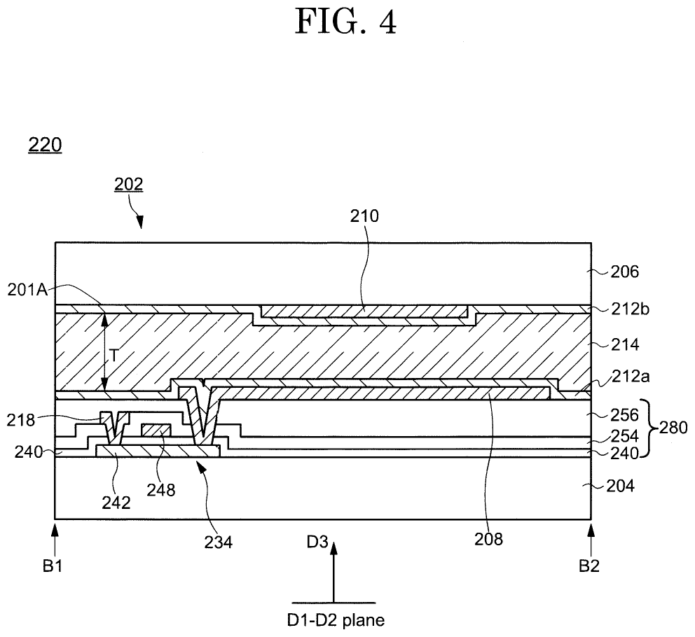

Although details will be described later, each of the plurality of reflector unit cells 202 is electrically connected to a corresponding scanning line and output signal line, and includes a bias electrode 208 (FIG. 4), a common electrode 210 (FIG. 4), and a liquid crystal layer 214 (FIG. 4) provided between the bias electrode 208 and the common electrode 210. The bias electrode 208 may be referred to as a first electrode, and the common electrode 210 may be referred to as a second electrode.

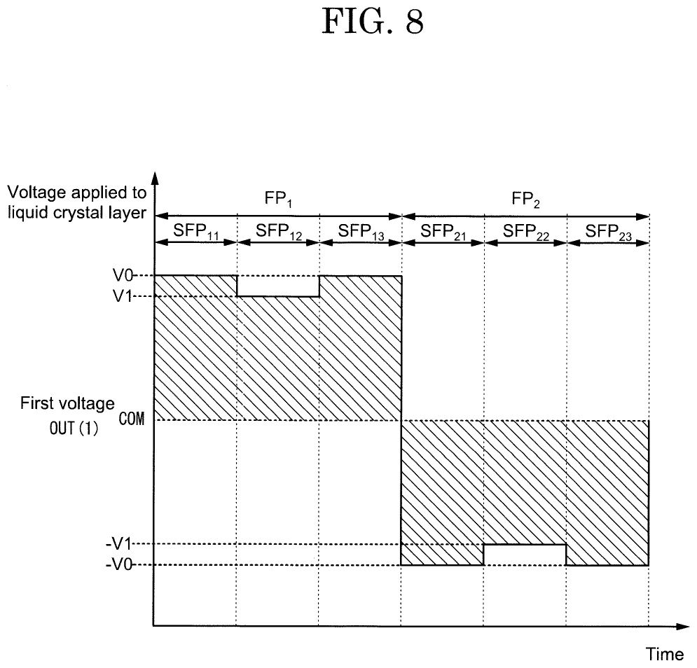

In addition, although details will be described later, a driving method for the radio wave reflecting device 200 is a time-division driving method for transmitting an output signal (for example, a first output signal OUT(1) to a m-th output signal OUT(m)) to the plurality of reflector unit cells 202 via the first output signal line 218a to the m-th output signal line 218d in a plurality of consecutive subframe periods SFP₁₁ to SFP₁₃ (for example, see FIG. 8).

For example, the driving method for the radio wave reflecting device 200 includes supplying a common voltage (voltage COM) to the common electrode 210 in one frame period FP₁ (see, e.g., FIG. 8) including the plurality of consecutive subframe periods SFP₁₁ to SFP₁₃ (see, e.g., FIG. 8), transmitting a scanning signal to the first scanning line 232a to the n-th scanning line 232d in each of the plurality of frame periods SFP₁₁ to SFP₁₃, and transmitting the output signals (e.g., the first output signal OUT(1) to the m-th output signal OUT(m)) to the plurality of reflector unit cells 202 via the first output signal line 218a to the m-th output signal line 218d in each of the plurality of frame periods SFP₁₁ to SFP₁₃.

The first output signal OUT(1) to the m-th output signal OUT(m) include voltages corresponding to phases for each of the plurality of reflector unit cells 202 to reflect an incident radio wave in a predetermined direction. Each of the plurality of reflector unit cells 202 (e.g., the reflector unit cells 202a to 202d) receives a voltage corresponding to different phases in each adjacent subframe period among the plurality of consecutive subframe periods SFP₁₁ to SFP₁₃.

Each of the plurality of reflector unit cells 202 (e.g., the reflector unit cells 202a to 202d) can receive a plurality of voltages corresponding to different phases in the time-division driving method and generate a predetermined voltage using a plurality of voltages corresponding to different phases. One predetermined voltage is a voltage corresponding to a phase for reflecting an incident radio wave in a predetermined direction.

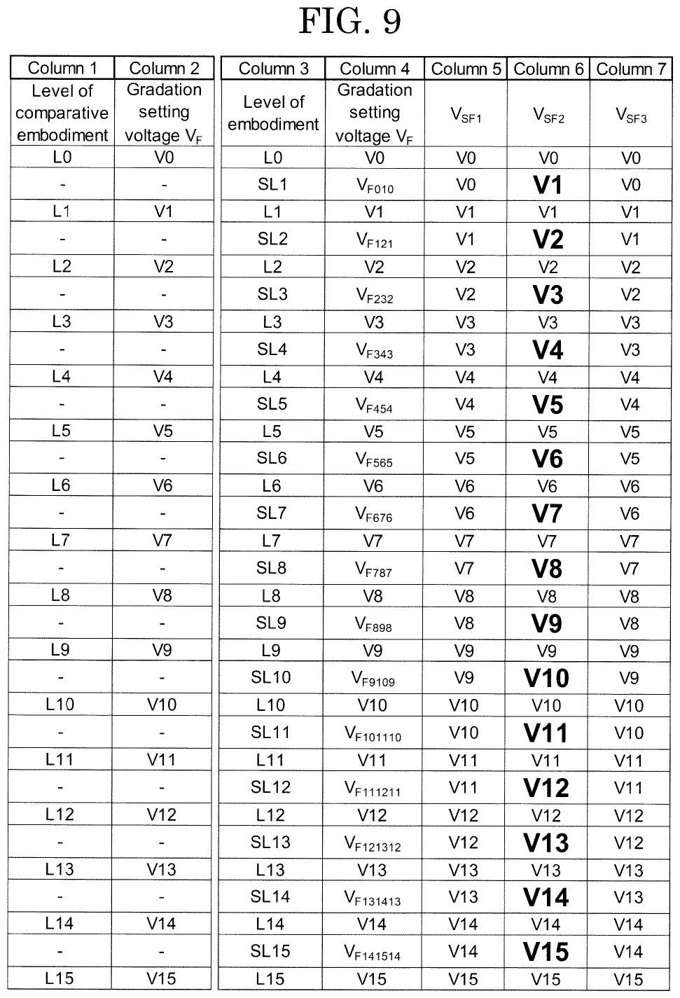

Although details will be described later, for example, the first driving circuit 224 can transmit any one of a voltage V0 to a voltage V15 (see FIG. 9) corresponding to phases of 16 levels (level L0 to level L16) similar to that of the driving circuit of the comparative example to the plurality of reflector unit cells 202, in each of the plurality of frame periods SFP₁₁ to SFP₁₃. The plurality of reflector unit cells 202 may receive a plurality of voltages of the voltages V0 to V15 in each of the plurality of frame periods SFP₁₁ to SFP₁₃ in the time-division driving method, and may generate one predetermined voltage (for example, see FIG. 9 (gradation setting voltage)) using the plurality of voltages among the voltages V0 to V15. One predetermined voltage is one of the voltages V0 to V15, or any voltage between each voltage (e.g., a voltage between the voltage V0 and the voltage V1).

Therefore, the driving method for the radio wave reflecting device 200 can generate a predetermined voltage corresponding to a phase different from the phases of 16 levels using the voltage V0 to the voltage V15 corresponding to the phase of the level L0 to the level L16 similar to that of the driving circuit of the comparative example. As a result, the driving method for the radio wave reflection device 200 can reflect the radio wave in a direction corresponding to more phases by using voltages corresponding to more phases than the phases of 16 levels. As a result, the driving method for the radio wave reflection device 200 can suppress deterioration of the reflection characteristics.

In addition, when distinguishing each of the plurality of radio wave reflecting unit cells, each of the plurality of radio wave reflecting unit cells is referred to as the plurality of reflector unit cells 202a to 202d, and when it is not necessary to distinguish each of the plurality of radio wave reflecting unit cells, the plurality of radio wave reflecting unit cells is referred to as the plurality of reflector unit cells 202. When distinguishing each of the plurality of output signal lines, each of a plurality of output signal lines is referred to as the first output signal line 218a to the m-th output signal line 218d, and when it is not necessary to distinguish each of the plurality of output signal lines, the plurality of output signal lines is referred to as a plurality of output signal lines 218. When distinguishing each of the plurality of output signals, each of the plurality of output signals is referred to as the first output signal OUT(1) to the m-th output signal OUT(m), and when it is not necessary to distinguish each of the plurality of output signals, the plurality of output signals is referred to as a plurality of output signals OUT. When distinguishing each of a plurality of scanning lines, each of the plurality of scanning lines is referred to as the first scanning line 232a to the n-th scanning line 232d, and when it is not necessary to distinguish each of the plurality of scanning lines, the plurality of scanning lines is referred to as a plurality of scanning lines 232. When distinguishing each of the plurality of scanning signals, each of the plurality of scanning signals is referred to as a first scanning signal SG(1) to an n-th scanning signal SG(n), and when it is not necessary to distinguish each of the plurality of scanning signals, the plurality of scanning signals is referred to as a plurality of scanning signals SG.

### 2. Configuration of Radio Wave Reflecting Device 200 and Reflector Unit Cell 202

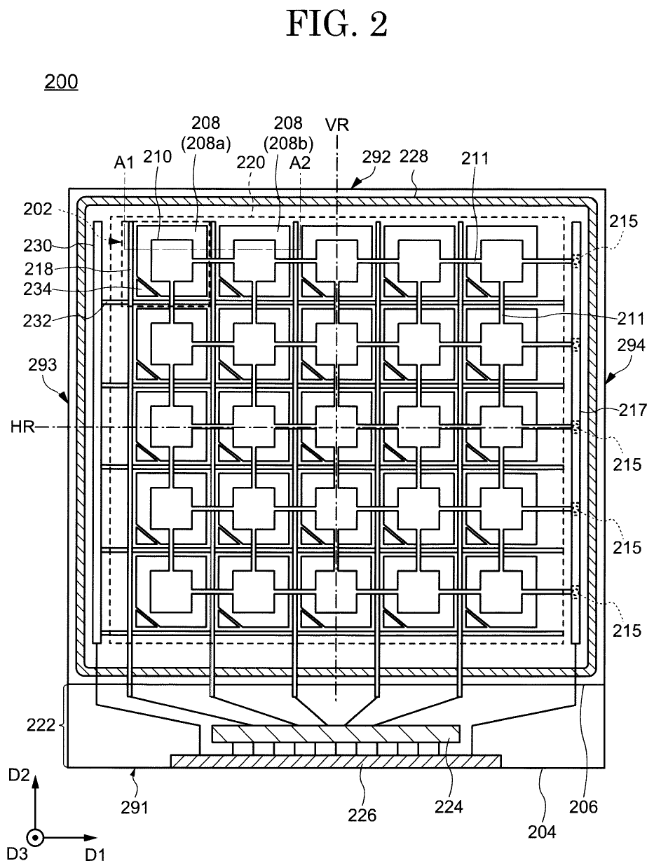

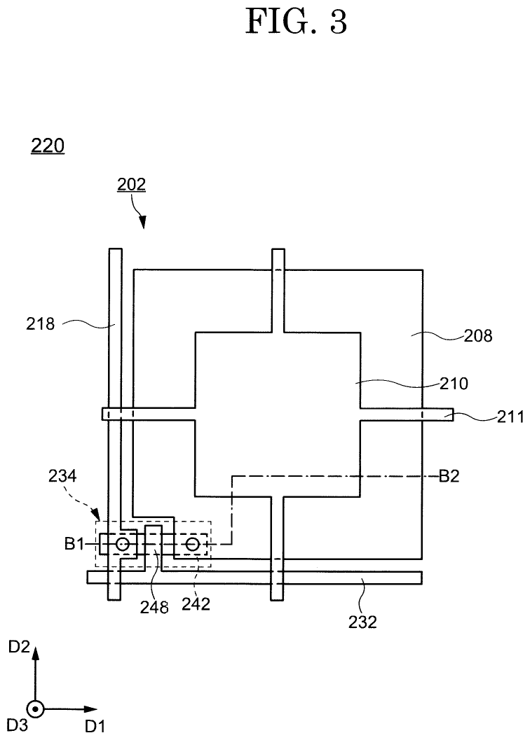

FIG. 2 is a plan view showing a configuration of the radio wave reflecting device 200. FIG. 3 is a plan view when the reflector unit cell 202 is viewed from above (the side where radio waves are incident), and more specifically, is an enlarged view of the arrangement of the bias electrode 208, the output signal line 218, and scanning line 232. A switching element 234 is provided between the output signal line 218 and the bias electrode 208. FIG. 4 is a cross-sectional view showing a cut surface taken along a line B1-B2 shown in FIG. 3, and more specifically, is a diagram showing an example of a cross-sectional structure of the reflector unit cell 202 in which the switching element 234 is connected to the bias electrode 208. Descriptions of the same or similar configurations as those in FIG. 1 will be omitted.

As shown in FIG. 2, the radio reflecting device 200 includes a dielectric substrate 204, a counter substrate 206, and a peripheral region 222. The radio wave reflecting device 200 (the dielectric substrate 204) has a first side 291 along the direction D1, a third side 293 intersecting the first side 291 along the direction D2, a second side 292 intersecting the third side 293 and facing parallel to the first side 291, and a fourth side 294 intersecting the first side 291 and the second side 292 and facing parallel to the third side 293. The counter substrate 206 overlaps the dielectric substrate 204 and the counter substrate 206 is bonded to the dielectric substrate 204 using a sealant 228. Although details will be described later, a region surrounded by the counter substrate 206, the dielectric substrate 204, and the sealant 228 includes the liquid crystal layer 214. In addition, the dielectric substrate 204 may be referred to as a first substrate, and the counter substrate 206 may be referred to as a second substrate.

A region of the dielectric substrate 204 except where the dielectric substrate 204 and the counter substrate 206 overlap is called the peripheral region 222. The peripheral region 222 includes the first driving circuit 224 and a terminal part 226 arranged on the dielectric substrate 204. The terminal part 226 is a region that connects to an external circuit. For example, a flexible printed circuit (not shown) is connected to the terminal part 226. A signal for controlling the first driving circuit 224 is input to the terminal part 226 from the flexible printed circuit.

A plurality of bias electrodes 208 is arranged on the dielectric substrate 204 in a matrix in the direction D1 and the direction D2.

The plurality of output signal lines 218 arranged in the dielectric substrate 204 extends in the direction D2 and extends to the peripheral region 222 and is connected to the first driving circuit 224. The output signal OUT corresponding to each of the plurality of output signal lines 218 is transmitted to the plurality of output signal lines 218 from the first driving circuit 224. For example, the plurality of scanning lines 232 arranged in the dielectric substrate 204 extends in the direction D1 and is connected to the second driving circuit 230. The scanning signal SG corresponding to each of the plurality of scanning lines 232 is transmitted to the plurality of scanning lines 232 from the second driving circuit 230.

A plurality of common electrodes 210 arranged on the counter substrate 206 is arranged in a matrix in the direction D1 and the direction D2, and is connected to a plurality of common wirings 211 extending in the direction D1 and the direction D2. The plurality of common wirings 211 is electrically connected via a connection portion 215 to a common wiring 217 arranged in the dielectric substrate 204 around the reflector 220 (e.g., inside the sealant 228 on the fourth side 294 side). The common wiring 217 extends to the peripheral region 222 and is connected to the terminal part 226. A common voltage is supplied from the terminal part 226 via the common wiring 217 and the connection portion 215 to the common electrode 210. For example, the common voltage may be the common voltage (voltage COM), a ground voltage (GND voltage), a 0V voltage, or a voltage VSS.

The radio wave reflecting device 200 can control the traveling direction of the reflected wave of the radio wave incident on the radio wave reflector 220 in the left-right direction of the drawing around a reflection axis VR parallel to the direction D2 (direction Y) and can also control the traveling direction of the reflected wave in the up-down direction of the drawing around a reflection axis HR parallel to the direction D1 (direction X). That is, the radio wave reflecting device 200 includes the reflection axis VR parallel to the direction D2 (direction Y) and a reflection axis VH parallel to the direction D1 (direction X), and can control the reflection angle in a direction with the reflection axis VR as the rotating axis and a direction with the reflection axis HR as the rotating axis.

As shown in FIG. 3, the reflector unit cell 202 is arranged such that the common electrode 210, the liquid crystal layer 214, and the bias electrode 208 overlap in a plan view. The reflector unit cell 202 includes the switching element 234. The switching element 234 connects the output signal line 218 and the bias electrode 208. The reflector unit cell 202 (the switching element 234) is electrically connected to the scanning line 232 and the output signal line 218.

The bias electrode 208 is formed to have a large area to function as a reflector. The bias electrode 208 has a larger area than the common electrode 210. The common electrode 210 is provided to overlap the bias electrode 208, and is arranged in a region inside the bias electrode 208. The bias electrode 208 is connected to the output signal line 218 via the switching element 234.

In addition, when distinguishing each of a plurality of switching elements of the reflector unit cells 202a to 202d, each of the plurality of switching elements is referred to as switching elements 234a to 234d, and when it is not necessary to distinguish each of the plurality of switching elements, the plurality of switching elements is referred to as a plurality of switching elements 234. When distinguishing each of the plurality of bias electrodes of the reflector unit cells 202a to 202d, each of the plurality of bias electrodes is referred to as bias electrodes 208a to 208d, and when it is not necessary to distinguish each of the plurality of bias electrodes, the plurality of bias electrodes is referred to as the plurality of bias electrodes 208.

In this case, an operation of the reflector unit cell 202a will be described as an example. For example, the switching (on/off) of the switching element 234a is controlled by the first scanning signal SG(1) transmitted to the first scanning line 232a. In response to the first scanning signal SG(1), the bias electrode 208a with the switching element 234a turned on is brought into conduction with the first output signal line 218a, and the first output signal OUT(1) is transmitted. For example, the switching element 234a is formed of a thin film transistor. The radio wave reflecting device 200 having such a configuration can select the plurality of bias electrodes 208 arranged in the direction D1 for each row in each period of the plurality of subframe periods SFP₁₁ to SFP₁₃ (see FIG. 8), and can transmit one voltage from among the voltage V0 to the voltage V15 to the selected bias electrode 208 among the plurality of bias electrodes 208 via the output signal line 218.

FIG. 4 is a diagram showing an example of a cross-sectional structure of the reflector unit cell 202 in which the switching element 234 is connected to the bias electrode 208. The switching element 234 is provided on the dielectric substrate 204. For example, the switching element 234 is formed of a transistor. The switching element 234 includes a structure in which a semiconductor layer 242, a gate insulating layer 240, and a gate electrode 248 on the dielectric substrate 204 are stacked. An undercoat layer may be provided between the semiconductor layer 242 and the dielectric substrate 204.

The scanning line 232 is formed in the same layer as the gate electrode 248 and is connected to the gate electrode 248. An interlayer insulating layer 254 is provided on the gate electrode 248, and the output signal line 218 is provided thereon. The output signal line 218 is provided in contact with the semiconductor layer 242 via a contact hole that penetrates the gate insulating layer 240 and the interlayer insulating layer 254.

A planarization layer 256 is provided to fill a step caused by the formation of the switching element 234 and the output signal line 218. The step of the switching element 234 can be filled by providing the planarization layer 256, so that the surface of the planarization layer 256 becomes flat. Therefore, the bias electrode 208 can be formed on the flat surface (front surface) of the planarization layer 256 without being affected by the step of the switching element 234. A passivation layer may be provided on the flat surface of the planarization layer 256.

The bias electrode 208 is provided on the planarization layer 256. The bias electrode 208 is connected to an input/output terminal (source/drain) of the switching element 234 (transistor) via a contact hole that penetrates the planarization layer 256, the interlayer insulating layer 254, and the gate insulating layer 240. In addition, the gate electrode 248 of the switching element 234 (transistor) is connected to the scanning line 232, and the input/output terminal (source/drain) that is not connected to the bias electrode 208 is connected to the output signal line 218. For example, an array layer 280 includes a conductive layer including the semiconductor layer 242, the gate insulating layer 240, and a first connection wiring 244, a conductive layer including the gate electrode 248 and the scanning line 232, a conductive layer including the interlayer insulating layer 254 and the output signal line 218, and the planarization layer 256. The array layer 280 may include a conductive layer forming the bias electrode 208 provided in the contact hole that penetrates the planarization layer 256, the interlayer insulating layer 254, and the gate insulating layer 240. A first alignment film 212a is provided on the bias electrode 208.

The plurality of common electrodes 210 and the plurality of common wirings 211 are provided on a first main surface 201A of the counter substrate 206. A second alignment film 212b is provided on the plurality of common electrodes 210 and the plurality of common wirings 211. The surface of the dielectric substrate 204 on which the switching element 234 and the bias electrode 208 are provided is arranged to face the first main surface 201A of the counter substrate 206. The liquid crystal layer 214 is provided between the first alignment film 212a and the second alignment film 212b. Although not shown, a spacer may be provided between the dielectric substrate 204 and the counter substrate 206 to maintain a constant spacing.

For example, a thickness T of the liquid crystal layer 214 may be 20 μm or more and less than 50 μm, and typically 30 μm or more and less than 40 μm. For example, the thickness T of the liquid crystal layer 214 of the radio wave reflecting device 200 is 35 μm. The thickness T of the liquid crystal layer 214 is sufficiently thicker than a thickness of a liquid crystal layer used in a liquid crystal display device (e.g., 2.0 μm or more and 5 μm or less). An electric field generated by the voltage applied between the two electrodes sandwiching the liquid crystal layer becomes smaller as the liquid crystal layer becomes thicker. That is, the thicker the liquid crystal layer, the more difficult it is for liquid crystal molecules to align, and the slower the response time of the liquid crystal molecules. Therefore, enough time is required for liquid crystal molecules 216 of the radio wave reflecting device 200 to respond based on the electric field generated by the voltage applied between the two electrodes sandwiching the liquid crystal layer.

In the case where the thickness T of the liquid crystal layer 214 of the radio wave reflecting device 200 is the thickness of the liquid crystal layer used in the typical liquid crystal display device, since the liquid crystal molecules 216 contained in the liquid crystal layer 214 are aligned following the speed (frequency) of the driving method for the radio wave reflecting device 200, the direction in which the radio wave reflecting device 200 reflects the radio wave is not fixed. Therefore, the thickness T of the liquid crystal layer 214 of the radio wave reflecting device 200 cannot be the thickness of the liquid crystal layer used in a typical liquid crystal display device. In addition, the speed (frequency) of the driving method for the radio wave reflecting device 200 needs to be sufficiently slow corresponding to the thickness T of the liquid crystal layer 214 of the radio wave reflecting device 200. Although details will be described later, the speed (frequency) of the driving method for the radio wave reflecting device 200 is sufficiently slower than the speed (frequency) of a typical liquid crystal display device.

Each layer formed on the dielectric substrate 204 is formed using the following materials. For example, the gate insulating layer 240 is formed of a silicon oxide film or a stacked structure of a silicon oxide film and a silicon nitride film. The semiconductor layer is formed of a silicon semiconductor such as amorphous silicon or polycrystalline silicon, or an oxide semiconductor containing a metal oxide such as indium oxide, zinc oxide, or gallium oxide. For example, the gate electrode 248 may be composed of molybdenum (Mo), tungsten (W), or an alloy thereof. The output signal line 218 and the scanning line 232 are formed using a metal material such as titanium (Ti), aluminum (Al), and molybdenum (Mo). For example, they may be composed of a stacked structure of titanium (Ti)/aluminum (Al)/titanium (Ti), or a stacked structure of molybdenum (Mo)/aluminum (Al)/molybdenum (Mo). The planarization layer 256 is formed of a resin material such as acrylic or polyimide. For example, the passivation layer 258 is formed of a silicon nitride film or the like. The bias electrode 208, the common electrode 210, and the common wiring 211 are formed of a metal film such as aluminum (Al) or copper (Cu), or a transparent conductive film such as indium tin oxide (ITO).

The scanning line 232 is connected to the gate electrode of the transistor used as the switching element 234, the output signal line 218 is connected to one of the source electrode and the drain electrode of the transistor, and the bias electrode 208 is connected to the other of the source electrode and the drain electrode. The radio wave reflecting device 200 is configured to select a predetermined bias electrode 208 from the plurality of bias electrodes 208 arranged in a matrix and transmit the output signal OUT via the output signal line 218. In addition, since the radio wave reflecting device 200 has a configuration in which the switching element 234 is provided in each of the bias electrodes 208 of the reflector 220, the driving method for the radio wave reflecting device 200 is configured to be capable of transmitting the output signal OUT for each of the bias electrodes 208 arranged parallel or substantially parallel to the direction D1 or for each of the bias electrodes 208 arranged parallel or substantially parallel to the direction D2.

### 3. Overview of Operation of Reflector 220 (Reflector Unit Cell 202)

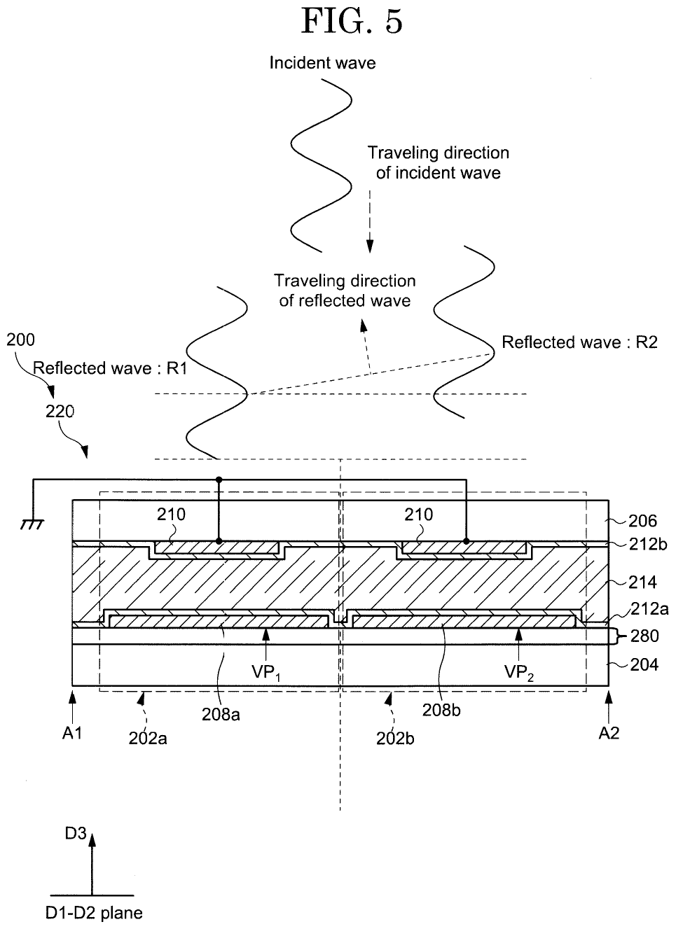

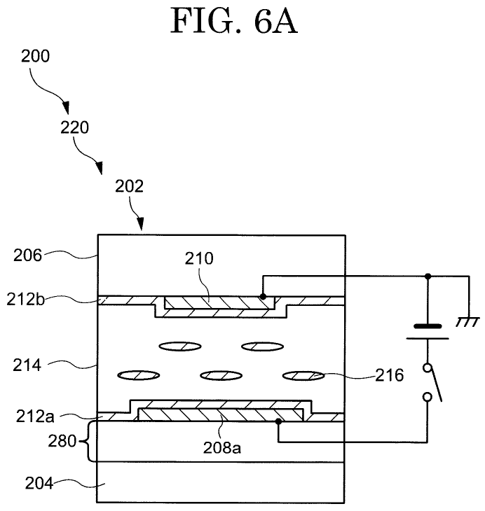

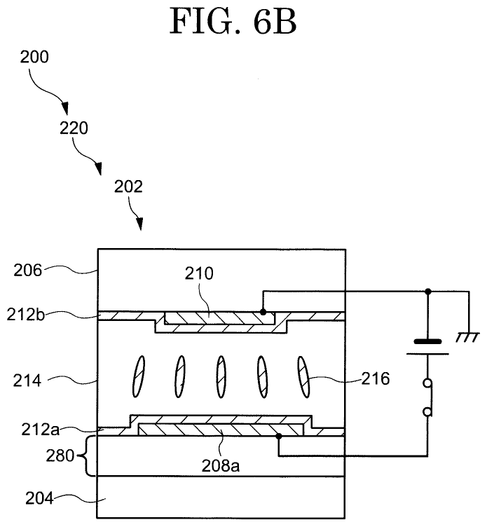

An overview of an operation of the reflector 220 (reflector unit cell 202) will be described with reference to FIG. 5 to FIG. 6B. FIG. 5 is a diagram schematically showing that the traveling direction of the reflected wave is changed by the reflector 220 (reflector unit cell 202), and is a diagram schematically showing a cross section cut along a line A1-A2 shown in FIG. 1. FIG. 6A is a diagram schematically showing a state in which no voltage is applied between the bias electrode 208 and the common electrode 210 in the reflector unit cell 202. FIG. 6B is a diagram showing a state in which a voltage is applied between the bias electrode 108 and the common electrode 210 in the reflector unit cell 202. Descriptions of the same or similar configurations as those in FIG. 1 to FIG. 4 will be omitted.

There is no restriction on the frequency of radio waves that can be reflected by the reflector unit cell 102. For example, the frequency of radio waves that can be reflected by the reflector unit cell 102 is 400 MHz to 300 GHz. Typically, the radio wave reflecting device 200 can be utilized to reflect radio waves in the 400 MHz to 6.0 GHz band, radio waves in the 2.5 GHz to 4.7 GHz band, and radio waves in the 24 GHz to 300 GHz band.

The radio wave reflecting device 200 reflects the radio wave in the traveling direction of the reflected wave with respect to the traveling direction of the incident wave. For example, the radio wave reflected by the radio wave reflecting device 200 is a radio wave corresponding to the 5G standard communication.

For example, one reflector unit cell 202 includes a portion of the dielectric substrate 204, a portion of the array layer 280, one bias electrode 208, a portion of the first alignment film 212a, a portion of the liquid crystal layer 214, a portion of the second alignment film 212b, a portion of the common electrode 210, and a portion of the counter substrate 206. The plurality of reflector unit cells 202 shares the dielectric substrate 204. Therefore, the dielectric substrate 204 can be regarded as a dielectric layer forming one layer. Therefore, the dielectric substrate 204 may be referred to as a dielectric layer.

As shown in FIG. 5, the reflector unit cell 202a includes the bias electrode 208a, and the reflector unit cell 202b includes the bias electrode 208b. The reflector unit cell 202a and the reflector unit cell 202b are adjacent along the direction D1 (or the direction D2). The bias electrode 208a is electrically connected to the first output signal line 218a and the bias electrode 208b is electrically connected to the second output signal line 218b.

For example, in the case where a radio wave is incident on the reflector unit cell 202a and the reflector unit cell 202b in the same phase, the first output signal OUT(1) including a voltage VP₁ is transmitted to the reflector unit cell 202a, and the second output signal OUT(2) including a voltage VP₂ is transmitted to the reflector unit cell 202b. For example, the voltage VP₁ is different from the voltage VP₂, and the voltage VP₁ is larger (higher) than the voltage VP₂. A change in phase of the reflected wave by the reflector unit cell 202b is greater than a change in phase of the reflected wave by the reflector unit cell 202a. Unlike the phase of a reflected wave R2 reflected by the reflector unit cell 202b, the traveling direction of the reflected wave of the phase of a reflected wave R1 reflected by the reflector unit cell 202a appears to change in the oblique direction. For example, in the example shown in FIG. 5, the phase of the reflected wave R2 leads the phase of the reflected wave R1.

For example, the output signal OUT for controlling the alignment of the liquid crystal molecules 216 of the liquid crystal layer 214 is transmitted to the bias electrode 208. For example, the output signal OUT is a signal of a DC voltage or a polarity-inverted signal in which a positive DC voltage and a negative DC voltage are alternately inverted. For example, the radio wave reflection device 200 transmits the polarity-inverted signal to the bias electrode 208. For example, the voltage COM is applied to the common electrode 210 of the radio wave reflecting device 200. For example, the voltage COM is an intermediate-level voltage of the polarity-inverted signal. In addition, a signal obtained by inverting the phase of the output signal supplied to the bias electrode 208 is supplied to the common electrode 210. When the output signal OUT is transmitted to the bias electrode 208, the alignment state of the liquid crystal molecules 216 contained in the liquid crystal layer 214 changes.

The reflector unit cell 202 can change the dielectric constant of the liquid crystal layer 214 by changing the alignment state of the liquid crystal molecules 216. As a result, when the radio wave reflecting device 200 (the reflector 220) reflects the radio wave, the phase of the reflected wave can be delayed.

The alignment state of the liquid crystal molecules 216 of the liquid crystal layer 214 changes depending on the output signal OUT transmitted to the bias electrode 208, but hardly follows the frequency of the radio wave incident on the bias electrode 208. Therefore, the reflector unit cell 202 can control the phase of the reflected radio wave without being affected by the incident radio wave.

FIG. 6A shows a state in which no voltage is applied between the bias electrode 208 and the common electrode 210 (referred to as a “first state”). FIG. 6A shows that the first alignment film 212a and the second alignment film 212b are horizontal alignment films. The long axis of the liquid crystal molecules 216 in the first state is aligned horizontally with respect to the front surface of the bias electrode 208 by the first alignment film 212a and the second alignment film 212b.

FIG. 6B shows a state in which the output signal OUT is transmitted to the bias electrode 208 (referred to as a “second state”). For example, in the second state, the liquid crystal molecules 216 are subjected to an electric field so that the long axis is aligned perpendicular to the surface of the bias electrode 208. The angle of the longitudinal axis of the liquid crystal molecules 216 may be aligned, depending on the magnitude of the output signal OUT supplied to the bias electrode 208, in an intermediate direction between the horizontal and vertical directions.

In the case where the liquid crystal molecules 216 have a positive dielectric anisotropy, the apparent dielectric constant of the second state is greater than that of the first state. Further, in the case where the liquid crystal molecules 216 have a negative dielectric anisotropy, the apparent dielectric constant of the second state is smaller than that of the first state. The liquid crystal layer 214 having dielectric anisotropy can be considered a variable dielectric layer. The reflector unit cell 202 can delay (or not delay) the phase of the reflected wave utilizing the dielectric anisotropy of the liquid crystal layer 214.

### 4. Driving Method for Radio Frequency Reflector 200

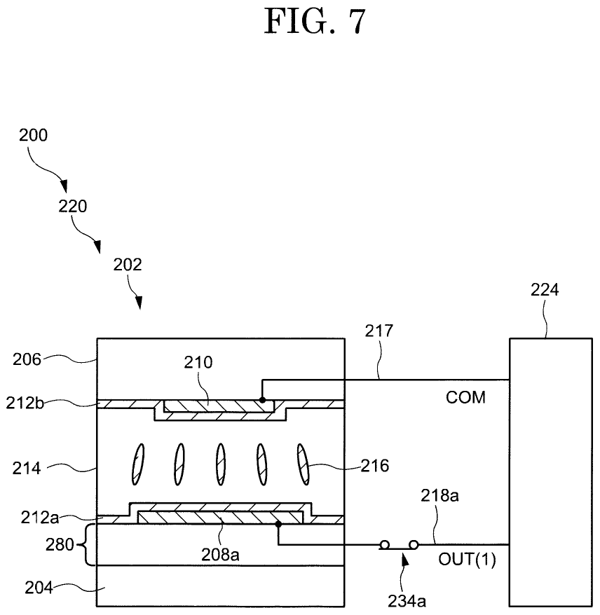

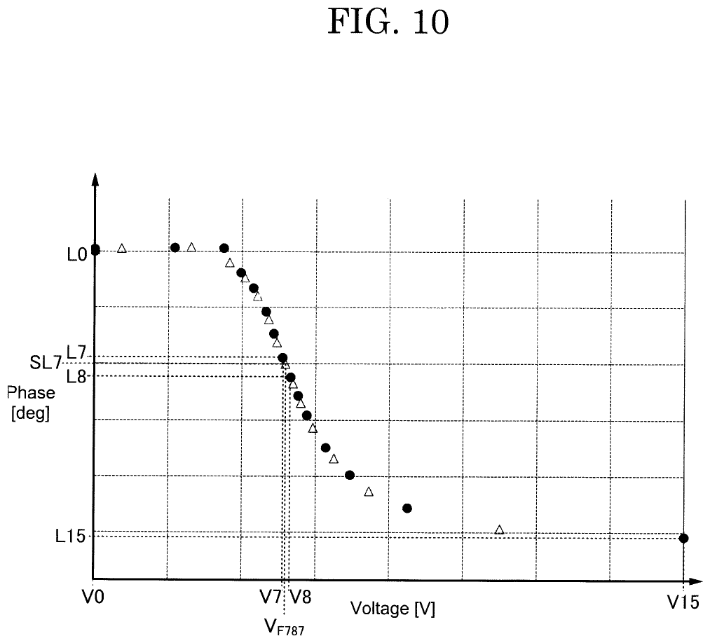

A driving method for the radio wave reflecting device 200 will be described with reference to FIG. 7 to FIG. 10. FIG. 7 is a diagram showing a state in which a voltage is applied between the bias electrode 208 and the common electrode 210 in the reflector unit cell 202 used in the radio wave reflection device 200. FIG. 8 is a timing chart showing a driving method for the radio wave reflection device 200. FIG. 9 is a diagram showing voltages (gradation setting voltages) that the first driving circuit 224 can transmit to the reflector unit cell 202 and can be generated (set) by the reflector unit cell 202. FIG. 10 is a graph showing a relationship between voltages (gradation setting voltage) that the first driving circuit 224 can transmit to the reflector unit cell 202 and can be generated (set) by the reflector unit cell 202 and the phases. Descriptions of the same or similar configurations as those in FIG. 1 to FIG. 6B will be omitted.

The configuration of the bias electrode 208a shown in FIG. 7 is similar to the configuration of the bias electrode 208 shown in FIG. 6B. The configuration of the bias electrode 208a shown in FIG. 7 different from the configuration of the bias electrode 208 shown in FIG. 6B will be described.

As shown in FIG. 7, the bias electrode 208a is electrically connected to the first output signal line 218a via the switching element 234a. For example, although not shown, the first scanning signal SG(1) is transmitted from the first driving circuit 224 via the first scanning line 232a to the switching element 234a, and the state of the switching element 234a is turned on. Therefore, the bias electrode 208a is electrically connected to the first output signal line 218a via the switching element 234a, and the first output OUT(1) is transmitted from the first driving circuit 224 via the first output signal line 218a to the bias electrode 208a. The voltage COM is transmitted from the first driving circuit 224 via the common wiring 217 to the common electrode 210.

As shown in FIG. 8, one frame period of the driving method for the radio wave reflecting device 200 includes the plurality of consecutive subframe periods. For example, the frame period FP₁ of one of the driving method for the radio wave reflecting device 200 includes the three consecutive subframe periods (first subframe period SFP₁₁, second subframe period SFP₁₂, and third subframe period SFP₁₃). In addition, the number of consecutive subframe periods may be two or four or more. Further, the horizontal axis shown in FIG. 8 represents time, and the vertical axis represents the voltage applied to the liquid crystal layer 214. The voltage applied to the liquid crystal layer 214 is the voltage V0, the voltage V15, or a voltage between the voltage V0 and the voltage V15.

For example, the frame period FP₁ plus the frame period FP₂ may be 33.4 ms or more and 100 ms or less, typically 40 ms or more and 66.8 ms or less. The frequency of the frame period FP₁ plus the frame period FP₂ may be 10 Hz or more and 30 Hz or less, typically 15 Hz or more and 25 Hz or less. For example, the frame period FP₁ plus the frame period FP₂ of the radio wave reflecting device 200 is 50 ms, and the frequency of the frame period FP₁ plus the frame period FP₂ of the radio wave reflecting device 200 is 20 Hz. For example, in the case where the frame period FP₁ includes the three subframe periods SFP₁₁ to SFP₁₃, each of the subframe periods SFP₁₁ to SFP₁₃ may be 5.56 ms or more and 16.7 ms or less, typically 6.66 ms or more and 11.1 ms or less. In addition, each frequency of the subframe periods SFP₁₁ to SFP₁₃ may be 60 Hz or more and 180 Hz or less, typically 90 Hz or more and 150 Hz or less.

The first electrode shown in FIG. 8 is the bias electrode 208a. The first output signal OUT(1) transmitted to the bias electrode 208a includes the voltage V0 in the first subframe period SFP₁₁, the voltage V1 in the second subframe period SFP₁₂ consecutive to the first subframe period SFP₁₁, and the voltage V0 in the third subframe period SFP₁₃ consecutive to the second subframe period SFP₁₂. The voltage V0 and the voltage V1 are higher (greater) than the voltage COM and the voltage V0 is greater than the voltage V1. That is, the voltages transmitted to the bias electrode 208a and the first output signal OUT(1) are higher (greater) in the first subframe period SFP₁₁ than in the second subframe period SFP₁₂.

Further, in each subframe period, the response speed of the liquid crystal molecules 216 whose alignment state changes according to the voltages transmitted to the bias electrode 208a and the first output signal Therefore, when attention is paid to the individual OUT(1) is slow. subframe periods, the liquid crystal molecules 216 may not be in the alignment state corresponding to the voltages transmitted to the bias electrode 208a and the first output signal OUT(1). When viewed in the frame period FP₁, the liquid crystal molecules 216 are in the alignment state according to the voltages transmitted to the bias electrode 208a and the first output signal OUT(1).

Since the response time (response speed) of the liquid crystal molecules 216 is slow in the driving method for the radio wave reflecting device 200, it takes a long time for the predetermined voltage to be transmitted to the bias electrode 208a. Therefore, for example, the driving method for the radio wave reflecting device 200 transmits the largest (higher) voltage to the bias electrode 208a and the first output signal OUT(1) in the first subframe period (for example, the first subframe period SFP₁₁) among the plurality of subframe periods. As a result, the driving method for the radio wave reflecting device 200 can shorten the time required for the liquid crystal molecules 216 to reach the alignment state corresponding to a predetermined voltage in the frame period FR₁ based on the so-called overdrive effect. In this case, for example, the overdrive effect is an effect of shortening the time required to reach a predetermined voltage by transmitting a high voltage corresponding to the predetermined voltage at the beginning of a certain period.

In the case where the liquid crystal molecules 216 reach the alignment state of the voltage according to a certain phase, and the response of the liquid crystal molecules 216 is slow, even if the voltage according to the phase changes in the subframe period, the driving method for the radio reflecting device 200 is configured so that the liquid crystal molecules 216 reach the alignment state according to a predetermined voltage.

Further, the subsequent frame period FP₂ following the frame period FP₁ of the driving method for the radio wave reflecting device 200 includes the three subframe periods (a first subframe period SFP₂₁, a second subframe period SFP₂₂, and a third subframe period SFP₂₃). In addition, the number of a plurality of consecutive subframe periods in the frame period FP₂ may be two or four or more, similar to the frame period FP₁.

The first output signal OUT(1) transmitted to the bias electrode 208a in the frame period FP₂ is a polarity-inverted signal in which the polarity of the first output signal OUT(1) transmitted to the bias electrode 208a in the frame period FP₁ is inverted.

Specifically, the first output signal OUT(1) transmitted to the bias electrode 208a in the first subframe period SFP₂₁ includes a voltage (voltage −V0) whose polarity of the voltage V0 transmitted in the first subframe period SFP₁₁ is negative. In the second subframe period SFP₂₂ consecutive to the first subframe period SFP₂₁, the first output signal OUT(1) transmitted to the bias electrode 208a includes a voltage (voltage −V1) whose polarity of the voltage V1 transmitted in the first subframe period SFP₁₂ is negative. The first output signal OUT(1) transmitted to the bias electrode 208a in the third subframe period SFP₂₃ consecutive to the second subframe period SFP₂₂ includes a voltage (voltage −V0) whose polarity of the voltage V0 transmitted in the first subframe period SFP₁₃ is negative. The voltage −V0 and the voltage −V1 are lower (smaller) than the voltage COM, and the voltage V0 is lower (smaller) than the voltage V1.

The reflector unit cell 202a (bias electrode 208a) receives the voltage V0, the voltage V1, and the voltage V0 in each of the three subframe periods SFP₁₁ to SFP₁₃ in the time-division driving method, and can generate a predetermined voltage (gradation setting voltage) using the voltage V0, the voltage V1, and the voltage V0. The gradation setting voltage is a voltage of either one of the voltages V0 to V15 or a voltage between each voltage (for example, a voltage between the voltage V0 and the voltage V1).

A gradation setting voltage V_{F} is calculated using the following Equation (1).

$${V}_{F} = \frac{{V}_{SF 1} + {V}_{SF 2} + {V}_{SF 3}}{3} \qquad ( 1 )$$

The voltage V_{SF1} of Equation (1) is a voltage included in the first output signal OUT(1) transmitted to the bias electrode 208a in the first subframe period, the voltage V_{SF2} of Equation (1) is a voltage included in the first output signal OUT(1) transmitted to the bias electrode 208a in the second subframe period, and the voltage V_{SF3} of Equation (1) is a voltage included in the first output signal OUT(1) transmitted to the bias electrode 208a in the third subframe period.

For example, a predetermined voltage (gradation setting voltage V_{F010}) generated by the bias electrode 208a using the voltage V0, the voltage V1, and the voltage V0 is expressed by the following Equation (2).

$$V 1 < {V}_{F 010} = \frac{V 0 + V 1 + V 0}{3} < V 0 \qquad ( 2 )$$

The gradation setting voltage V_{F010} is a voltage between the voltage V0 and the voltage V1, that is, a voltage greater than the voltage V1 and smaller than the voltage V0. Further, in the case where the output signal OUT is the polarity-inverted signal whose polarity is inverted, the voltage V_{SF1}, the voltage V_{SF2}, the voltage V_{SF3}, the voltage V_{F010}, the voltage V0, and the voltage V1 are negative voltages. In this case, the gradation setting voltage V_{F} is calculated by entering the absolute value of each negative voltage into the voltage V_{SF1}, the voltage V_{SF2}, the voltage V_{SF3}, the voltage V_{F010}, the voltage V0, and the voltage V1 shown in Equation (1) and Equation (2).

For example, the gradation setting voltage V_{F} that can be generated by the driving method for the radio wave reflecting device 200 is shown in FIG. 9 and FIG. 10.

The driving method for a driving circuit of the comparative example does not correspond to the time-division driving method such as the driving method for the radio wave reflecting device 200. Therefore, the driving method for the driving circuit of the comparative example does not supply a voltage in each of the subframes, but supplies a voltage in one frame. As shown in FIG. 9, for example, the driving circuit of the comparative example transmits any one of the voltage V0 to the voltage V15 corresponding to the phases of 16 levels (level 0 to level 15) to the reflector unit cell. Referring to FIG. 9, the gradation setting voltage of level 7 of the driving circuit of the comparative example is the voltage V7, and the gradation setting voltage of level 12 of the driving circuit of the comparative example is the voltage V12.

On the other hand, the driving method for the radio wave reflecting device 200 (the first driving circuit 224) is the time-division driving method including the three subframe periods (first subframe period SFP₂₁, second subframe period SFP₂₂, and third subframe period SFP₂₃) as described above. The driving method for the radio wave reflecting device 200 (the first driving circuit 224) can transmit to the reflector unit cell 202, the voltage V_{SF1}, the voltage V_{SF2}, and the voltage V_{SF3} corresponding to the phases of 16 levels (level 0 to level 15), respectively, in the first subframe period SFP₂₁, the second subframe period SFP₂₂, and the third subframe period SFP₂₃. The reflector unit cell 202 can receive the voltage V_{SF1}, the voltage V_{SF2}, and the voltage V_{SF3}, and can generate one gradation setting voltage V_{F} corresponding to the phases of the level 0 to the level 15 or the phases other than the level 0 to the level 15. The gradation setting voltage V_{F} corresponding to the phases of the level 0 to the level 15 is the voltage V0 to the voltage V15, and the gradation setting voltage V_{F} corresponding to the phases other than the level 0 to the level 15 is any voltage between each voltage (for example, a voltage between the voltage V0 and the voltage V1).

As shown in FIG. 9, for example, the driving method for the radio wave reflecting device 200 (the first driving circuit 224) can transmit the voltage V7 to the reflector unit cell 202 in each of the first subframe period SFP₂₁, the second subframe period SFP₂₂, and the third subframe period SFP₂₃, and can generate one gradation setting voltage V_{F} (voltage V7) based on Equation (1). In addition, the radio wave reflecting device 200 (the first driving circuit 224) can transmit the voltage V7, the voltage V8, and the voltage V7 to the reflector unit cell 202 in each of the first subframe period SFP₂₁, the second subframe period SFP₂₂, and the third subframe period SFP₂₃, and can generate one gradation setting voltage V_{F} (voltage V_{F787}) based on Equation (2). The voltage V₇₈₇ is the voltage between the voltage V7 and the voltage V8.

Similar to the case where the voltage V7, the voltage V8, and the voltage V7 are transmitted to the reflector unit cell 202, the driving method for the radio wave reflecting device 200 (the first driving circuit 224) can transmit each voltage shown in FIG. 9 to the reflector unit cell 202 in each subframe period. In addition, the reflector unit cell 202 may generate one gradation setting voltage V_{F} (e.g., voltage V7) based on Equation (1) using the transmitted voltage. As shown in bold in the cells of the column 6 of FIG. 9, in the driving method for the radio wave reflecting device 200 (the first driving circuit 224), the voltage transmitted in the second subframe period SFP₂₂ is different from the voltage transmitted in each period of the first subframe period SFP₁₁ and the third subframe period SFP₁₃, and the voltage transmitted in the second subframe period SFP₂₂ may be lower (smaller) than the voltage transmitted in each period of the first subframe period SFP₁₁ and the third subframe period SFP₁₃. In addition, the combination of the voltage V_{SF1}, the voltage V_{SF2}, and the voltage V_{SF3} at the time of generating (setting) each gradation setting voltage V_{F} is not limited to the combination of the voltages shown in FIG. 9.

The open triangular marker (Δ) shown in FIG. 10 indicates the voltage V0 to the voltage V15 corresponding to the phases of 16 levels (level L0 to level L16), and the black circle marker (●) shown in FIG. 10 indicates the voltage V_{F010} to a voltage V_{F141514} corresponding to a phase between the level L0 to the level L16. The driving method for the radio wave reflecting device 200 (the first driving circuit 224) shows an example in which 30 levels of voltage shown in FIG. 9 and FIG. 10 can be set. For example, the driving method for the radio wave reflecting device 200 (the first driving circuit 224) based on the graphs shown in FIG. 9 and FIG. 10 shows an example in which the voltages set in the first subframe period SFP₂₁ and the third subframe period SFP₂₃ and the voltages set in the second subframe period SFP₂₂ are different.

The driving method for the radio wave reflecting device 200 (the first driving circuit 224) is not limited to the example shown in FIG. 9 and FIG. 10. In the radio wave reflecting device 200 (the first driving circuit 224), the voltage V0 to the voltage V15 corresponding to the phase between the level 0 to the level 15 may be set in the reflector unit cell 202 in each period of the first subframe period SFP₂₁, the second subframe period SFP₂₂, and the third subframe period SFP₂₃. As a result, the reflector unit cell 202 can generate the gradation setting voltage V_{F} corresponding to three times the respective levels from the level 0 to the level 15, that is, the phases of 16×3=48 levels. For example, the radio wave reflecting device 200 (the first driving circuit 224) may thin out the gradation setting voltage V_{F} corresponding to the phases of 48 levels so as to use the gradation setting voltage V_{F} corresponding to the phases of the levels in a steeply sloped region of the graph shown in FIG. 10. In addition, the radio wave reflection device 200 and the driving method for the radio wave reflection device 200 may be configured to further subdivide each voltage and set (generate) a voltage corresponding to more phases. The driving method for the radio wave reflecting device 200 (the first driving circuit 224) can appropriately set the gradation setting V_{F} depending on the specifications or applications of the radio wave reflecting device 200.

As described above, the driving method for the radio wave reflecting device 200 (the first driving circuit 224) can cause the reflector unit cell 202 to generate (set) the gradation setting voltage V_{F} corresponding to the phases between the level 0 to the level 15. Therefore, the driving method for the radio wave reflection device 200 can reflect radio waves in a direction corresponding to more phases by using voltages corresponding to more phases than the phases of 16 levels. As a result, the driving method for the radio wave reflection device 200 can suppress deterioration of the reflection characteristics.

### Second Embodiment

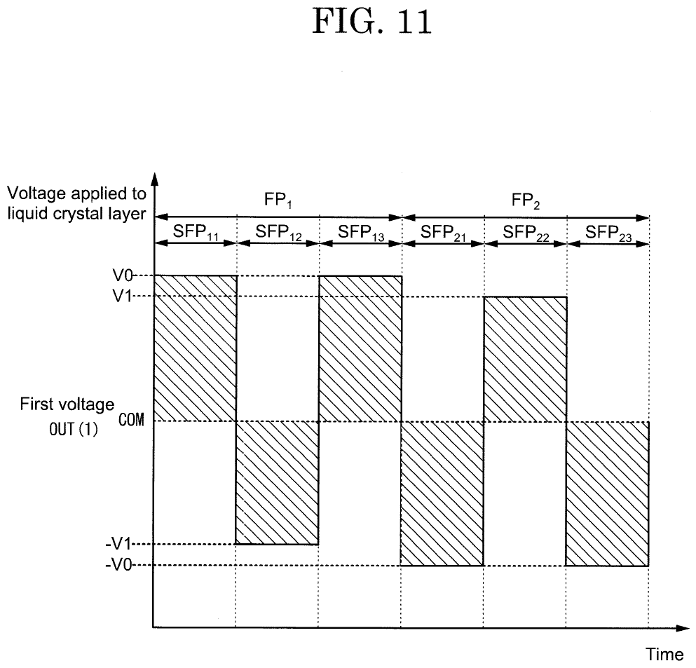

A driving method for the radio wave reflection device 200 according to the second embodiment will be described with reference to FIG. 11. The driving method for the radio wave reflecting device 200 according to the second embodiment includes inverting the polarity of the voltage included in the output signal OUT transmitted to the bias electrode 208 in adjacent subframe periods. The driving method for the radio wave reflecting device 200 according to the second embodiment is similar to the configurations and functions of the radio wave reflecting device 200 according to the first embodiment and the driving method for the radio wave reflecting device 200 according to the first embodiment, except that the polarity of the voltage included in the output signal OUT transmitted to the bias electrodes 208 in adjacent subframe periods is inverted. Therefore, the driving method for the radio wave reflecting device 200 according to the second embodiment will be mainly described focusing on the differences from the driving method for the radio wave reflecting device 200 according to the first embodiment. Descriptions of the same or similar configurations as those in FIG. 1 to FIG. 10 will be omitted.

The first output signal OUT(1) transmitted to the bias electrode 208a in the subframe period SFP₁₂ is a polarity-inverted signal in which the polarity of the first output signal OUT(1) transmitted to the bias electrode 208a in the frame period SFP₁₁ is inverted.

Specifically, the voltage of the first output signal OUT(1) transmitted in the first subframe period SFP₁₁ includes a voltage (voltage V0) of positive polarity, and the first output signal OUT(1) transmitted to the bias electrode 208a in the second subframe period SFP₁₂ following the first subframe period SFP₁₁ includes a voltage (voltage −V1) of negative polarity in which the polarity of the first output signal OUT(1) transmitted in the first subframe period SFP₁₁ is inverted. In this case, the voltage COM is applied to the common electrode 210. The voltage of negative polarity (voltage −V1) is a voltage with the voltage COM as a reference voltage.

For example, in the driving method shown in the second embodiment, the first output signal OUT transmitted in the first subframe period SFP₁₁(1) and the first output signal OUT(1) transmitted to the bias electrode 208a in the second subframe period SFP₂₁ are signals with the polarity inverted with respect to the voltage COM.

Similar to the first output signal OUT(1) transmitted in the first subframe period SFP₁₁ and the first output signal OUT(1) transmitted to the bias electrode OUT(1) in the second subframe period SFP₂₁, the first output signal OUT(1) transmitted in the third subframe period SFP₁₃, and the first output signal OUT(1) transmitted in the first subframe period SFP₂₁ (the first subframe period SFP₂₁ of the frame period FP₂) following the third subframe period SFP₁₃ are signals with the polarity inverted.

Further, in the driving method for the radio wave reflecting device 200 according to the second embodiment, similar to the driving method according to the first embodiment, the first output signal OUT(1) transmitted to the bias electrode 208a in the frame period FP₂ is the polarity-inverted signal in which the polarity of the first output signal OUT(1) transmitted to the bias electrode 208a in the frame period FP₁ is inverted.

The driving method for the radio wave reflecting device 200 according to the second embodiment can use the polarity inversion in the frame period FP₁ and the frame period FP₂ and the polarity inversion in the adjacent subframe periods. Therefore, the driving method for the radio wave reflecting device 200 according to the second embodiment can further suppress burn-in in the liquid crystal layer as compared with the case where the polarity inversion is not performed.

As described above, the radio wave reflecting device 200 according to the second embodiment can reflect radio waves in a direction corresponding to more phases by using voltages corresponding to more phases than the phases of 16 levels, and can further suppress burn-in in the liquid crystal layer. As a result, the driving method for the radio wave reflection device 200 according to the second embodiment can suppress deterioration of the reflection characteristics.

### Third Embodiment

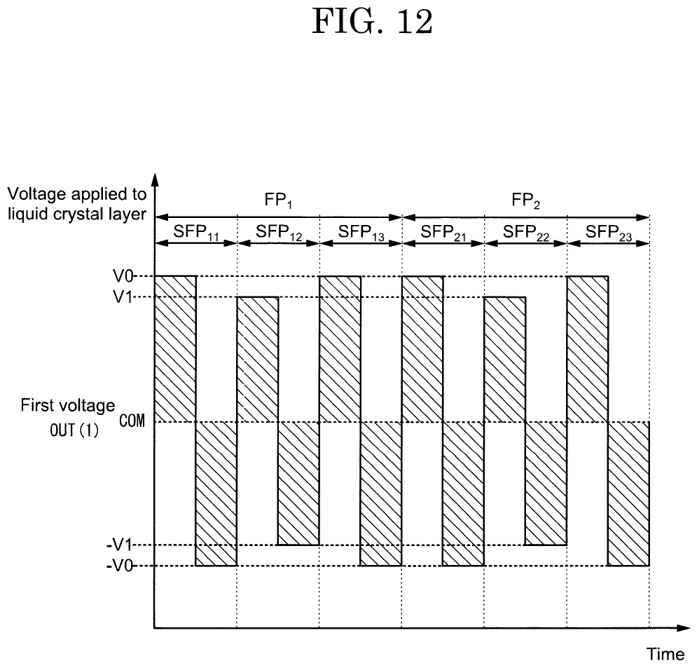

A driving method for the radio wave reflection device 200 according to the third embodiment will be described with reference to FIG. 12. The radio wave reflecting device 200 according to the third embodiment includes inverting the polarity of the voltage included in the output signal OUT transmitted to the bias electrode 208 in each subframe period. The driving method for the radio wave reflecting device 200 according to the third embodiment is similar to the configurations and functions of the radio wave reflecting device 200 according to the first embodiment and the driving method for the radio wave reflecting device 200 according to the first embodiment, except that the polarity of the voltage included in the output signal OUT transmitted to the bias electrodes 208 is inverted in each subframe period. Therefore, the driving method for the radio wave reflecting device 200 according to the third embodiment will be mainly described focusing on the differences from the driving method for the radio wave reflecting device 200 according to the first embodiment. Descriptions of the same or similar configurations as those in FIG. 1 to FIG. 11 will be omitted.

The first output signal OUT(1) transmitted to the bias electrode 208a in the subframe period SFP₁₂ includes signals with the polarity inverted.

Specifically, the voltage of the first output signal OUT(1) transmitted in the first subframe period SFP₁₂ includes the voltage of positive polarity (voltage V0) shown in FIG. 12 and the voltage of negative polarity (voltage −V0) with the polarity inverted with the voltage COM as a reference voltage.

Similar to the first output signal OUT(1) transmitted in the first subframe period SFP₁₁, the voltages of the first output signal OUT(1) transmitted in the second subframe period SFP₁₂ following the first subframe period SFP₁₁ to the third subframe period SFP₂₃ include a positive voltage, and a negative voltage with the polarity inverted with respect to the voltage COM.

In addition, similar to the driving method according to the second embodiment, the driving method for the radio wave reflection device 200 according to the third embodiment can perform polarity inversion in adjacent subframe periods.

The driving method for the radio wave reflecting device 200 according to the third embodiment can use the polarity inversion in the frame period FP₁ and the frame period FP₂, the polarity inversion in the adjacent subframe periods, and the polarity inversion in each subframe period. Therefore, the driving method for the radio wave reflecting device 200 according to the third embodiment can further suppress burn-in in the liquid crystal layer as compared with the case where the polarity inversion is not performed.

As described above, the radio wave reflecting device 200 according to the third embodiment can reflect radio waves in a direction corresponding to more phases by using voltages corresponding to more phases than the phases of 16 levels, and can further suppress burn-in in the liquid crystal layer. As a result, the driving method for the radio wave reflection device 200 according to the third embodiment can suppress deterioration of the reflection characteristics.

### Fourth Embodiment

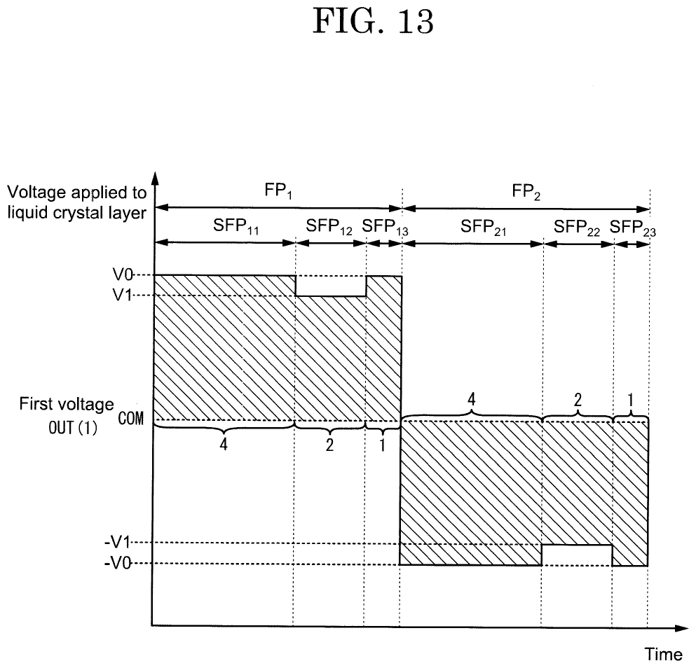

A driving method for the radio wave reflection device 200 according to the fourth embodiment will be described with reference to FIG. 13. The driving method for the radio wave reflecting device 200 according to the fourth embodiment is a PWM (pulse-width modulation) driving method. The PWM driving method is a method for controlling the transmission time of the output signal OUT transmitted to the bias electrode 208 in each subframe period. For example, since the PWM driving method is a method known in display devices, a detailed explanation thereof will be omitted. The driving method for the radio wave reflecting device 200 according to the fourth embodiment is similar to the configurations and functions of the radio wave reflecting device 200 according to the first embodiment and the driving method for the radio wave reflecting device 200 according to the first embodiment, except that the driving method is the PWM driving method. Therefore, the driving method for the radio wave reflecting device 200 according to the third embodiment will be mainly described focusing on the differences from the driving method for the radio wave reflecting device 200 according to the first embodiment. Descriptions of the same or similar configurations as those in FIG. 1 to FIG. 12 will be omitted.

For example, similar to the driving method for the radio wave reflecting device 200 according to the first embodiment, in the driving method for the radio wave reflecting device 200 according to the fourth embodiment, an example is shown in which the voltage (voltage V0) set in the first subframe period SFP₂₁ and the third subframe period SFP₂₃ is different from the voltage (voltage V1) set in the second subframe period SFP₂₂.

For example, in the driving method for the radio wave reflecting device 200 according to the fourth embodiment, the transmission time of the first output signal OUT(1) transmitted to the reflector unit cell 202a (bias electrode 208a) in the subframe period SFP₁₁, the time generated (set) by the reflector unit cell 202a, the transmission time of the first output signal OUT(1) transmitted to the reflector unit cell 202a (bias electrode 208a) in the subframe period SFP₁₂, the time generated (set) by the reflector unit cell 202a, the transmission time of the first output signal OUT(1) transmitted to the reflector unit cell 202a (bias electrode 208a) in the subframe period SFP₁₃, and the time generated (set) by the reflector unit cell 202a are different.

Specifically, the radio wave reflecting device 200 according to the fourth embodiment controls the first output signal OUT(1) at a ratio of 4:2:1, with respect to the transmission time and the time generated (set) in the subframe period SFP₁₁, the transmission time and the time generated (set) in the subframe period SFP₁₂, and the transmission time and the time generated (set) in the subframe period SFP₁₃.

In addition, similar to the driving method according to the first embodiment, the first output signal OUT(1) transmitted to the bias electrode 208a in the frame period FP₂ in the driving method for the radio wave reflecting device 200 according to the fourth embodiment is the polarity-inverted signal in which the polarity of the first output signal OUT(1) transmitted to the bias electrode 208a in the frame period FP₁ is inverted. Similar to the frame period FP₁, in the period FP₂, the radio wave reflecting device 200 according to the fourth embodiment controls the first output signal OUT(1) at a ratio of 4:2:1, with respect to the transmission time and the time generated (set) in the subframe period SFP₂₁, the transmission time and the time generated (set) in the subframe period SFP₂₂, and the transmission time and the time generated (set) in the subframe period SFP₂₃. In addition, the ratio is not limited to 4:2:1, and can be appropriately determined within a range that does not deviate from the driving method for the radio wave reflecting device 200 depending on the specifications and applications of the radio wave reflecting device 200.

The driving method for the radio wave reflecting device 200 according to the third embodiment can use the polarity inversion in the frame period FP₁ and the frame period FP₂, the polarity inversion in adjacent subframe periods, and the polarity inversion in each subframe period. Therefore, the driving method for the radio wave reflecting device 200 according to the third embodiment can further suppress burn-in in the liquid crystal layer as compared with the case where the polarity inversion is not performed.

As described above, in the driving method (PWM driving method) of the radio wave reflecting device 200 according to the fourth embodiment, radio waves can be reflected in a direction corresponding to more phases by using voltages corresponding to more phases than the phases of 16 levels. As a result, the driving method for the radio wave reflection device 200 according to the fourth embodiment can suppress deterioration of the reflection characteristics.

### Fifth Embodiment

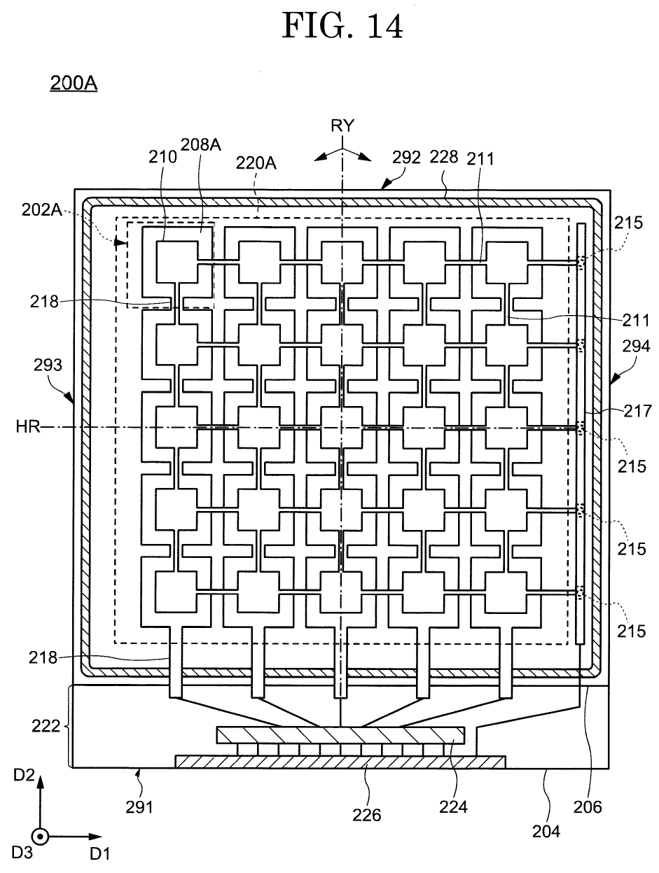

In the fifth embodiment, a radio wave reflecting device 200A that allows uniaxial reflection control will be described. A reflection axis RY of the radio wave reflection device 200A is uniaxial. The radio wave reflection device 200A can control the reflection angle with the reflection axis RY as the rotation axis. The radio wave reflection device 200A is different from the radio wave reflection device 200 in that uniaxial reflection control can be performed. The radio reflecting device 200A does not include at least the array layer 280, the plurality of scanning lines 232, and the second driving circuit 230 as compared with the radio reflecting device 200. In the fifth embodiment, differences from the first to fourth embodiments will be mainly described with reference to FIG. 14.

FIG. 14 is a plan view showing a configuration of the radio wave reflecting device 200A. Descriptions of the same or similar configurations as those in FIG. 1 to FIG. 13 will be omitted.

As shown in FIG. 14, the radio wave reflecting device 200A includes a reflector 220A. Similar to the reflector 220, the reflector 220A includes a plurality of reflector unit cells 202A arranged in a matrix in the direction D1 and the direction D2, and has a structure in which the plurality of reflector unit cells 202A is integrated. The reflector unit cell 202A does not include the scanning line 232 and the switching element 234 according to the first embodiment, and the bias electrode 208 is electrically connected to the output signal line 218. Since the reflector unit cell 202A does not include the switching element 234, the bias electrode 208 may be formed in a square shape. Similar to the reflector 220 according to the first embodiment, the reflector 220A is provided between the dielectric substrate 204 and the counter substrate 206.

Similar to the radio wave reflecting device 200 that allows biaxial reflection control, the radio wave reflecting device 200A that allows uniaxial reflection control according to the fifth embodiment can reflect radio waves in a direction corresponding to more phases by using voltages corresponding to more phases than the phases of 16 levels, and can suppress deterioration of the reflection characteristics.

The configurations of the radio wave reflecting device and the configurations of the driving method for the radio wave reflecting device exemplified as an embodiment of the present invention can be combined as long as there is no contradiction. In addition, the configurations of the radio wave reflecting device and the configurations of the driving method for the radio wave reflecting device exemplified as an embodiment of the present invention can be interchanged as long as there is no contradiction. Further, the addition, deletion, or design change of components, or the addition, deletion, or condition change of processes as appropriate by those skilled in the art based on the radio wave reflecting device and the driving method for the radio wave reflecting device are also included in the scope of the present invention as long as they are provided with the gist of the present invention.

Further, it is understood that, even if the effect is different from those provided by each of the above-described embodiments, the effect obvious from the description in the specification or easily predicted by persons ordinarily skilled in the art is apparently derived from the present invention.

What is claimed is:

1. A driving method for an intelligent reflecting surface, the intelligent reflecting surface comprising:
a first output signal line to an mth (m is an integer of 2 or more) output signal line; and
a plurality of reflector unit cells each electrically connected to a corresponding one of the first output signal line to the mth output signal line, each having a first electrode, a second electrode, and a liquid crystal layer provided between the first electrode and the second electrode;
the driving method comprises:
transmitting a common voltage to the second electrode in a plurality of consecutive subframe periods included in a frame period; and
transmitting an output signal to the plurality of reflector unit cells through the first output signal line to the mth output signal line in each period of the plurality of subframe periods,
wherein the output signal includes a voltage corresponding to a phase for reflecting an incident radio wave in a predetermined direction during each adjacent subframe period among the plurality of subframe periods, and
each of the plurality of reflector unit cells receives a voltage corresponding to the phase during each adjacent subframe period among the plurality of subframe periods, and generates one voltage using the voltages corresponding to the plurality of phases.

2. The driving method according to claim 1, wherein
the plurality of subframe periods includes a first subframe period and a second subframe period following the first subframe period, and
the voltage corresponding to the phase received by each of the plurality of reflector unit cells during the first subframe period is higher than the voltage corresponding to the phase received during the second subframe period.

3. The driving method according to claim 2, wherein the polarity of the voltage corresponding to the phase received in the second subframe period is the same as the polarity of the voltage corresponding to the phase received in the first subframe period.

4. The driving method according to claim 2, wherein the polarity of the voltage corresponding to the phase received in the second subframe period is different from the polarity of the voltage corresponding to the phase received in the first subframe period.

5. The driving method according to claim 1, wherein the frame period is longer than the response time of liquid crystal molecules contained in the liquid crystal layer.

6. The driving method according to claim 5,
wherein the thickness of the liquid crystal layer is 30 μm or more and less than 40 μm.

7. The driving method according to claim 2,
wherein the one voltage is an average voltage obtained by adding a voltage corresponding to a phase received in the first subframe period and a voltage corresponding to a phase received in the second subframe period.

8. The driving method according to claim 2,
wherein a voltage corresponding to a phase received in the first subframe period includes a voltage of positive polarity, and a voltage of negative polarity with the polarity inverted with respect to the common voltage.

9. The driving method according to claim 2, wherein the plurality of subframe periods includes a third subframe period following the second subframe period, and a ratio of the first subframe period, the second subframe period, and the third subframe period is 4:2:1.

10. The driving method according to claim 1, wherein the driving method is a time division driving method.
